(19) United States
(12) Patent Application Publication
(10) Pub. No.: US 2026/0219513 A1
(43) Pub. Date: Jul. 30, 2026

(54) WEARABLE DISPLAY DEVICE

(71) Applicant: Apple Inc., Cupertino, CA (US)

(72) Inventors: Amanda Y. Lin, Cupertino, CA (US); Adam H. Herzog, Sunnyvale, CA (US); Paul X. Wang, Cupertino, CA (US); Xi Xi, San Francisco, CA (US); Zhenishbek Zhakypov, Mountain View, CA (US); Zoe V. Marazita, Winston Salem, NC (US)

(21) Appl. No.: 19/356,402

(22) Filed: Oct. 13, 2025

Related U.S. Application Data
(60) Provisional application No. 63/749,792, filed on Jan. 27, 2025.

(51) Int. Cl. G02C 5/12; G02B 27/01

(52) U.S. Cl. CPC G02C 5/12; G02B 27/0176; G02B 2027/0178

(57) ABSTRACT

A wearable display device can include a display, a display housing at least partially surrounding the display, and a nosepiece configured to be removably coupled to the display housing. The nosepiece includes a stem configured to be received by the display housing, a first strut extending away from the stem at a first angle, a first pad coupled to the first strut distal to the stem, a second strut extending away from the stem at a second angle, and a second pad coupled to the second strut distal to the stem.

### CROSS-REFERENCE TO RELATED APPLICATIONS

This application claims the benefit of U.S. Provisional Application No. 63/749,792, filed 27 January 2025, entitled “WEARABLE DISPLAY DEVICE,” the entire disclosure of which is hereby incorporated by reference.

### FIELD

The present disclosure relates generally to wearable display devices. More particularly, the present disclosure relates to an attachable nosepiece for wearable display devices.

### BACKGROUND

Various components of wearable display devices, such as head-mountable displays (HMD), can include as display screens, viewing frames, securement arms, speakers, batteries, waveguides, and other components, which operate together to provide an immersive experience. User’s heads vary in size and shape, and more specifically the size and shape of a user’s nose, can vary from user to user. Display screens provide the most optimal immersive experience when the HMD is positioned directly in front of the user’s eyes and can ideally be worn for extended periods of time. However, many HMD nosepieces cannot be adjusted to comfortable position the HMD. Therefore, there is a need for an HMD with an effective and simple-to-use nosepiece to position the HMD comfortably and securely.

### SUMMARY

At least one example of the present disclosure includes a wearable display device including a display, a display housing at least partially surrounding the display, and a nosepiece configured to be removably coupled to the display housing. The nosepiece includes a stem configured to be received by the display housing, a first strut extending away from the stem at a first angle, a first pad coupled to the first strut distal to the stem, a second strut extending away from the stem at a second angle, and a second pad coupled to the second strut distal to the stem.

The display housing can define a first eye region, a second eye region, and a central region extending between the first eye region and the second eye region. The central region can define a receptacle configured to receive the stem of the nosepiece. The first strut can extend from the stem with a first curvature and the second strut can extend from the stem with a second curvature. The first angle and the second angle can be adjustable. The stem and the display housing can be removably coupled via at least one of a magnet, a detent, or a snap lock. The nosepiece can be removably coupled to the display housing to define a first stem angle or a second stem angle of the stem relative to the display housing. The first pad can be removably coupled to the first strut and the second pad can be removably coupled to the second strut. The first pad and the second pad can be removably coupled to the first strut and the second strut via at least one of a snap fit, rails, or magnets. The first pad and the second pad can be removably coupled to the first strut and the second strut at a first distance or a second distance. The first strut can be configured to telescope to modify a first length of the first strut and the second strut can be configured to telescope to modify a second length of the second strut. The first pad can include a first pressure sensor, and the second pad can include a second pressure sensor.

In at least one example of the present disclosure, a wearable display device includes a display, a display housing defining a central region including a receptacle, and a nosepiece. The nosepiece can include a stem configured to be received by the receptacle at a first angle, and removably coupled to the central region of the display housing. The nosepiece can also include a first strut extending away from the stem with a first curvature, a first pad removably coupled to the first strut, a second strut extending away from the stem with a second curvature, and a second pad removably coupled to the second strut.

The distance between the first pad and the second pad can be adjustable. The location of the first pad and the second pad on the first strut and the second strut can be adjustable. The stem can be configured to electrically couple to the display housing. The first pad can be configured to electrically couple to the first strut and the second pad can be configured to electrically couple to the second strut. The receptacle can be configured to receive the stem at the first angle, a second angle, and a third angle. The second curvature can be mirrored from the first curvature.

In at least one example of the present disclosure, a nosepiece includes a stem including a connector. The connector can be configured to be removably coupled to a wearable display device and the connector can be configured to electrically couple the nosepiece to the wearable display device. The nosepiece can also include a first strut extending away from the stem with a first curvature, a second strut extending away from the stem with a second curvature, a first pad removably coupled to the first strut, and a second pad removably coupled to the second strut. The first pad can include a first sensor electrically couplable to the connector and the second pad can include a second sensor electrically couplable to the connector. The first sensor can be a first pressure sensor, and the second sensor can be a second pressure sensor.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates top view of one example of a wearable display device including a nosepiece;

FIG. 2A illustrates a top view of one example of a nosepiece;

FIG. 2B illustrates a top view of another example of a nosepiece;

FIG. 3 illustrates a cross sectional side view of one example of a wearable display device and a nosepiece;

FIG. 4 illustrates a perspective view of one example of a nosepiece and nosepiece pads; and

FIG. 5 illustrates a top view of one example of electronic components of a wearable display device and nosepiece.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described embodiments as defined by the appended claims.

The present disclosure generally relates to electronic devices. More particularly, the present disclosure relates to wearable display devices. In at least one example, a wearable display device can include a display housing and a securement arm extending from the display housing. Examples of head-mountable devices can include optical devices, for example glasses lenses, goggles with lenses, transparent display windows, display screens or virtual/augmented reality devices that can include optical components. In these examples, the head-mountable device can be donned on the head of a user such that optically transparent widows, for example lenses and transparent optical displays, can be positioned in front of a user’s eyes. User’s noses can vary in size and shape. Display screens or display lenses provide the optimal immersive experience when the lenses are positioned directly in front of the user’s eyes and can be comfortably worn for extended periods of time. However, the adjustment of the nosepiece to match a user’s nose anatomy can be difficult as small adjustments to the nosepiece of the wearable display devices can affect the immersive experience delivered to the user and the time of wearability for the wearable display devices. Devices, systems, and methods described herein include head mountable display devices having adjustable nosepieces to accommodate various nose anatomies to increase comfort for the end user and reduce the costs associated with designing and manufacturing multiple nosepiece SKUs or customized nosepieces for each end user. Rather, the nosepieces described herein can be a single SKU to be adjusted, removed, reattached, and customized for each user as needed.

In at least one example, the head-mountable device or wearable display device can include a removably coupled nosepiece. By providing a removably coupled nosepiece, a user can change the nosepiece to a nosepiece that best suits the nose of the user. Based on different sizes and shapes of a nose, the user can have different needs for a nosepiece. While noses have similar areas of sensitivity, differences in shapes and sizes can cause variations in the size and shape of the sensitive areas, and the amount of pressure applied by a nosepiece. In an example, the nosepiece can include pads that can be removably coupled to the struts. By providing removably couplable pads, a user can change the pads to pads that best suit the nose of the user. The customization of the nosepiece of the wearable display device enhances comfort and can increase the duration of wearability.

For example, different nosepieces can have different breadths, depths, and/or heights. The nosepieces can include struts that extend at different angles to establish different breadths. In an example, the angle of the struts can be adjusted to modify the breadth. The nosepieces can include struts of different lengths to establish different depths. In an example, the structs can be configured to telescope to modify the length and/or depth. The nosepiece can couple to the wearable display device at different angles, thus providing different heights for the nosepiece. The pads can include a variety of shapes, sizes, stiffnesses, thickness, etc. to optimize comfort.

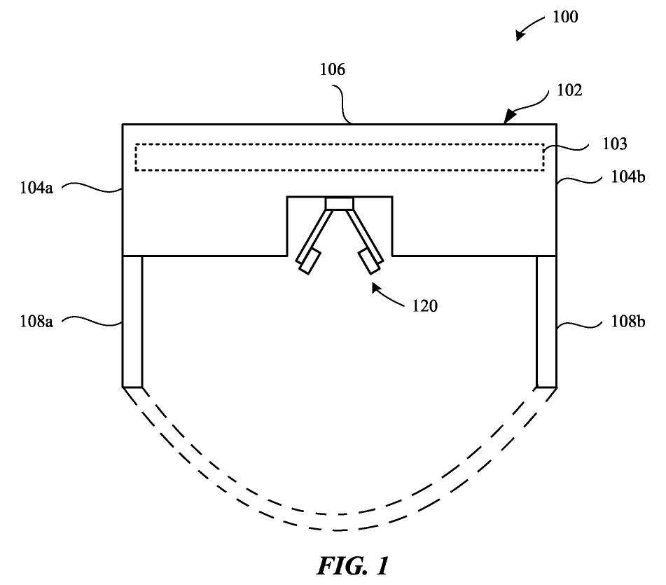

These and other embodiments are discussed below with reference to FIGS. 1-5. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates top view of one example of a wearable display device 100 and a nosepiece 120. The wearable display device 100 can be a head-mountable display (HMD) or can be any device or system configured to be worn on the head of a user, such as an optical device, smart glasses, alternate/virtual reality goggles, and the like. As shown in FIG. 1, the wearable display device 100 can include at least one display housing 102 which can house a variety of components and systems, including a display 103 and electronics or electronic components. In at least one example, the display housing 102 can be configured to secure a display window, display screen, and/or lenses configured to present visual information to the user.

In one example of the present disclosure, the wearable display device 100 can include a first eye region 104a integrated into the display housing 102 and a second eye region 104b integrated into the display housing 102. The first and second eye regions 104a-b can be configured to be positioned proximal the eyes of a user. The first and second eye regions 104a-b can include transparent windows, glass, apertures, etc. The first and second eye regions 104a-b can direct the users eyes to a single display or multiple displays, depending on the configuration.

The display housing 102 can also include a central region 106. The central region 106 can be configured to be positioned proximal, on top of, or against the nose of a user. The central region 106 can have a different depth, height, or other configuration than the first and second eye regions 104a-b. The central region 106 can include a nosepiece 120. The nosepiece 120, as described herein, can be removably coupled to the central region 106 of the display housing 102.

The wearable display device 100 can include one or more securement arms 108a-b. The securement arms 108a-b can be arms, straps, rigs, or other features configured to attach the wearable display device 100 to a user’s head and can extend from the display housing 102 to secure the wearable display device 100 to the user. For example, the securement arms 108a-b can secure the wearable display device 100 to the ears of the users, to the head of the user, or a combination thereof.

The nosepiece 120 can secure the wearable display device 100 to the user by engaging with, resting on, or securing the wearable display device 100 to the nose of the user. The nosepiece 120 can assist with aligning the wearable display device 100, such as the first and second eye regions 104a-b, with the eyes of the user. Alignment with the eyes can enhance user experience and comfort. The nosepiece 120 can assist with supporting the weight of the wearable display device 100 while permitting the user to wear the wearable display device 100 for extended periods of time. To accommodate various users, the nosepiece 120 can be adjustable and removably coupled to the display housing 102, as described in further detail herein.

Any of the features, components, and/or parts, of the wearable display device including the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

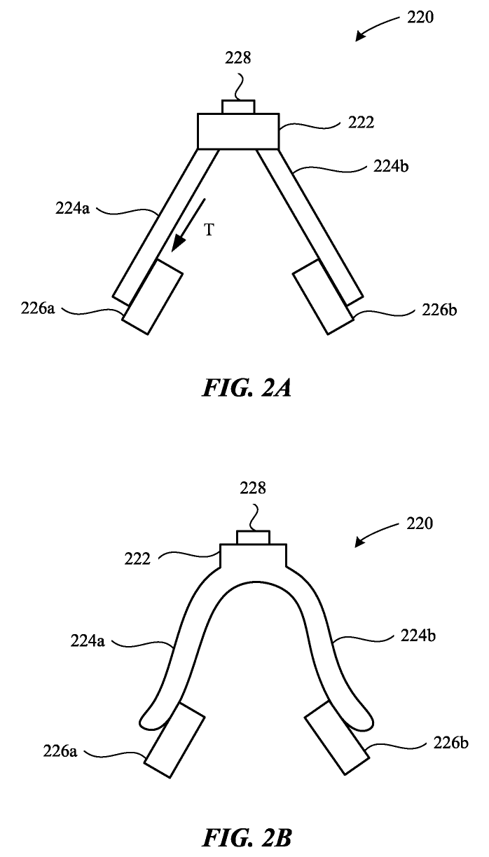

FIGS. 2A and 2B illustrate a top view of one example of a nosepiece 220. While the nosepiece 220 is illustrated, because the nosepiece 220 can be removably coupled to the display housing, a user can interchange multiple nosepieces on a wearable display device. For example, the user can have multiple nosepieces 220 that are slightly different in shape or size. The nosepiece 220 can be received by the central region of the display housing. While some display housings can have different shapes to accommodate various interpupillary distances, the nosepiece 220 can be configured to fit within the central region. The nosepiece 220 can include a stem 222 and struts 224a-b.

The stem 222 can be configured to be received by the display housing, such as the central region of the display housing. For example, the stem 222 can include a connector 228 to couple to the display housing. The connector 228 can include a magnet, a detent, a snap lock, or other means of removably coupling to the display housing.

The struts 224a-b can extend from the stem 222 to define a breadth of the nosepiece 220. The first strut 224a can extend from the stem 222 at a first angle and the second strut 224b can extend from the stem 222 at a second angle. The first and second angles can be mirrored from one another. In an example, the first and second angle can be modified. As illustrated in FIG. 2B, the struts 224a-b can include a curvature. For example, the first strut 224a can extend from the stem 222 with a first curvature and the second strut 224b can extend from the stem 222 with a second curvature. The first and second curvatures can be mirrored from one another. The struts 224a-b can include a stiffness configured to permits the struts 224a-b to conform to the nose of the user. The shape of the struts 224a-b can be configured to aid in avoiding regions of nose that cause irritation or increased pressure, such as the bridge of the nose, near the eyes, the tip of the nose, etc. The struts 224a-b can also define a depth of the nosepiece 220 based on a length of the struts 224a-b. In one example, the struts 224a-b can be configured to telescope in a direction T to modify a length of the struts 224a-b.

The struts 224a-b can include pads 226a-b. The pads 226a-b can be positioned on the distal end of the struts 224a-b, away from the stem 222. The pads 226a-b can be positioned to face inwards, or towards one another. The pads 226a-b can be configured to disperse pressure on the nose of the user, thus increasing comfort and wearability.

In an example, the wearable display device can include features to assist with positioning of the wearable display device, such as the nosepiece. For example, the wearable display device can scan the face of the user and display a recommended nosepiece. In another example, based on the scan, the wearable display device can provide a guide for adjusting the nosepiece for optimal use. In another example, the wearable display device can display recommendations for adjustments or modifications for optimal viewing, such that the user can adjust the nosepiece 220. For example, the wearable display device may display an image and recommend the user adjust the nosepiece 220 until the image is in a designated location or orientation with respect to the user’s eyes. For example, poor positioning may cause the display housing to block a portion of the user’s viewable area, and the recommendation may assist with proper alignment of the nosepiece 220 to fully capture the display image without interference.

Any of the features, components, and/or parts, of the nosepiece 220 including the arrangements and configurations thereof shown in FIGS. 2A and 2B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 2A and 2B.

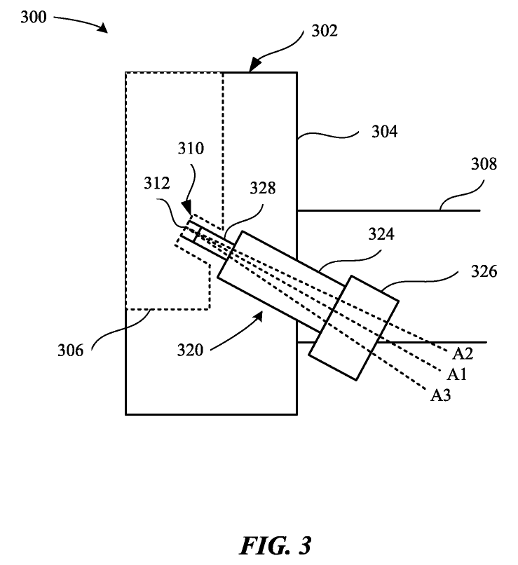

FIG. 3 illustrates a cross sectional side view of one example of a wearable display device 300 and a nosepiece 320. The wearable display device 300 can include at least one display housing 302 which can house a variety of components and systems. In at least one example, the display housing 302 can be configured to secure a display window, display screen, and/or lenses configured to present visual information to the user.

In one example of the present disclosure, the wearable display device 300 can include an eye region 304 integrated into the display housing 302. The eye region 304 can be configured to be positioned proximal an eye of a user. The eye region 304 can include transparent windows, glass, apertures, etc. The eye regions 304 can direct the user’s eyes to a single display or multiple displays, depending on the configuration.

The display housing 302 can also include a central region 306. The central region 306 can be configured to be positioned proximal, on top of, or against the nose of a user. The central region 306 can have a different depth, height, or other configuration than the eye region 304. The central region 306 can include a receptacle 310. The receptacle 310 can be configured to receive a nosepiece 320. The receptacle 310 can be positioned at an angle A1 with respect to the central region 306 and/or the eye region 304, such that the receptacle 310 receives the nosepiece 320 at an angle. The receptacle 310 can include a coupler 312 to removably couple the nosepiece 320.

The coupler 312 can removably couple the connector 328 of the nosepiece 320. The coupler 312 and connector 328 can removably couple via magnets, detent, snap locks, etc. The receptacle 310, coupler 312, or combination thereof, can include an O-ring, seal, or securement device to assist with securing the nosepiece 320. In an example, the connection between the coupler 312 and connector 328 can facilitate an electrical connection to facilitate the exchange of data.

In an example, the angle A1 between the nosepiece 320 and the display housing 302 is adjustable. For example, the receptacle 310 can be sized and shaped to enable the nosepiece 320 to be received at multiple angles, such as A2 and A3. Further, the coupler 312 or the connector 328 can include an angle adjustment mechanism. The angle adjustment mechanism can modify the angle between the nosepiece 320 and the display housing 302. The adjustment mechanism can be a detent, a friction hinge, an actuation mechanism, a sliding mechanism, locked positions, etc. By adjusting the angle between the nosepiece 320 and the display housing 302, the wearable display device can be adjusted in relation to the eyes of the user. Thus, the user can adjust for a more optimal display position. By adjusting the angle of the nosepiece 320, the angle of a strut 324 and a pad 326 of the nosepiece 320 can similarly be adjusted.

The wearable display device 300 can include one or more securement arms 308. The securement arms 308 can extend from the display housing 302 to secure the wearable display device 300 to the user. For example, the securement arm 308 secure the wearable display device 300 to the ears of the users, to the head of the user, or a combination thereof.

Any of the features, components, and/or parts, of the wearable display device 300 including the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

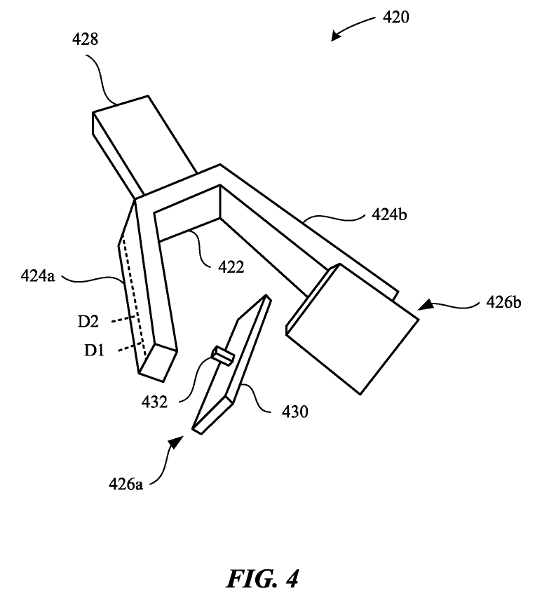

FIG. 4 illustrates a perspective view of one example of a nosepiece 420 and nosepiece pads 426a and 426b. The nosepiece 220 can include a stem 422 and struts 424a-b.

The stem 422 can be configured to be received by the display housing, such as the central region of the display housing. For example, the stem 422 can include a connector 428 to couple to the display housing. The connector 428 can extend from the stem 422 to removably couple to the display housing. The connector 428 can include a magnet, a detent, a snap lock, or other means of removably coupling to the display housing.

The struts 424a-b can extend from the stem 422 to define a breadth of the nosepiece 420. The first strut 424a can extend from the stem 422 at a first angle and the second strut 424b can extend from the stem 422 at a second angle. The first and second angles can be mirrored from one another. In an example, the first and second angles can be modified, such as by a user. In one example, the struts 424a-b can include a curvature. For example, the first strut 424a can extend from the stem 422 with a first curvature and the second strut 424b can extend from the stem 422 with a second curvature. The first and second curvatures can be mirrored from one another. The struts 424a-b can include a stiffness configured to permits the struts 424a-b to conform to the nose of the user. The shape of the struts 424a-b can be configured to aid in avoiding regions of nose that cause irritation or increased pressure, such as the bridge of the nose, near the eyes of the user, the tip of the nose, etc. The struts 424a-b can also define a depth of the nosepiece 420 based on a length of the struts 424a-b. In one example, the struts 424a-b can be configured to telescope to modify a length of the struts 424a-b.

The struts 424a-b can include pads 426a-b. The pads 426a-b can be positioned on the distal end of the struts 424a-b, away from the stem 422. The pads 426a-b can be positioned to face inwards, or towards one another. The pads 426a-b can be configured to disperse pressure on the nose of the user, thus increasing comfort and wearability. The shape and size of the nose of the user can influence areas of sensitivity and amounts of sensitivity. For example, a smaller pad can sufficiently disperse pressure for a smaller nose but can cause a high-pressure area for a larger nose. In an example, the pads 426a-b can be removably coupled to the struts 424a-b. Thus, the pads 426a-b can be changed to a different set of pads that are better suited for the user. As illustrated with respect to pad 426a, pad 426a can include a pad portion 430 and a connection portion 432.

The pad portion 430 can be various sizes, including small, medium, and large. The pad portion 430 can be various shapes, including a teardrop, a circle, an oval, an elliptical, a square, a parallelogram, a pentagon, etc. The pad portion 430 can have different thicknesses, including thin, thick, varying thickness across the pad portion 430, etc. The pad portion 430 can include grooves or a plurality of small protrusions, similar to a gecko. The pad portion 430 can be substantially flat, curved, rounded, etc. The pad portion 430 can have different levels of stiffness to accommodate different users. The pad portion 430 can be made of material to aid in securing the pad 426a, and therefore the nosepiece 420 to the nose of the user. In an example, the pad portion 430 can include micro textures on the surface, a UV coating, a soft-touch coating, a silicone covered foam, a high friction material, a sticky or tacky material, etc.

The connection portion 432 can extend from the pad portion 430 to removably couple the pad 426a to the nosepiece 420. For example, the connection portion 432 can removably couple the pad 426a to the strut 424a. The connection portion 432 can removably couple via a snap fit, magnets, a rail, etc. In an example, pad 426a can removably couple to the nosepiece 420, such as the strut 424a, at multiple locations. For example, the pad 426a can removably couple at a first distance D1 from the stem 422 or a second distance D2 from the stem 422. In an example where the pad 426a connects via a rail, the pad 426a can be configured to move along the rail to multiple locations along the strut 424a. The connection portion 432 can include electrical or data connections to the nosepiece 420. The connection portion 432, via the nosepiece 420 and connector 428, can include electrical or data connections to the wearable display device or display housing. While described and illustrated with respect to pad 426a, pad 426b can share similar features and configurations.

In an example, the pads 426a-b can include sensors. The sensor can track health conditions or metrics, such as respiration, nostril movement, septum deviation, etc. For example, the pad portion 430 can include a pressure sensor. The pressure sensor can aid in positioning the wearable display device and/or the nosepiece 420. For example, the pressure sensor can provide pressure information to the wearable display device, which can provide feedback to the user via the display regarding recommendation on adjustments or modifications to the nosepiece 420 positioning or components for improved comfort, wearability, or usability.

In an example, the scan by the wearable display device can be used to create custom pads 426a-b. The scan can be used to create 3D printed pads 426a-b, or pad portion 430. For example, carbon 3D printing could be used to create the pads 426a-b. The stiffness of the pads 426a-b can be varied based on the needs of the user. Different levels of stiffness in the pads 426a-b can create different levels of tightness of the nosepiece 420 for the user. In another example, the pads 426a-b can be custom made from molds. A UV tiered material can be molded to the nose of the user to form the pads 426a-b, then attached to the struts 424a-b. Once attached, the pads 426a-b can be UV cured to create custom pads 426a-b. In another example, the pads 426a-b can be thermally adjustably. For example, the pads 426a-b can be heat activated to allow a user to mold the pads 426a-b to the nose of the user. Once the pads 426a-b, the pads 426a-b can hold the shape to create custom pads 426a-b for the user.

Any of the features, components, and/or parts, of the nosepiece 420 including the arrangements and configurations thereof shown in FIG. 4 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4.

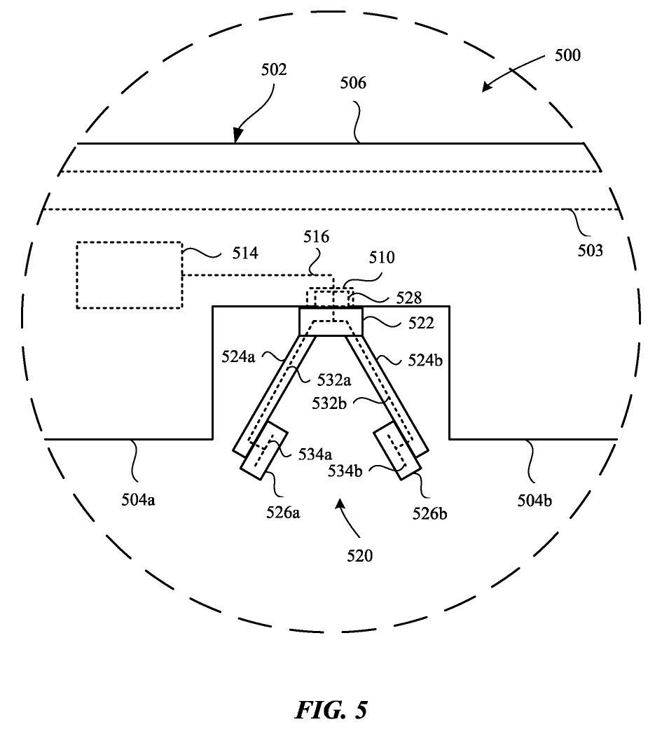

FIG. 5 illustrates top view of one example of electronic components of a wearable display device 500 and a nosepiece 520. The wearable display device 500 can be a head-mountable device (HMD) or can be any device or system configured to be worn on the head of a user, such as an optical device, smart glasses, alternate/virtual reality goggles, and the like. As shown in FIG. 5, the device 500 can include at least one display housing 502 which can house a variety of components and systems, including a display 503 and electrical component 514. In at least one example, the display housing 502 can be configured to secure a display window, display screen, and/or lenses configured to present visual information to the user. The electrical component 514 or electronic can be any one of a controller, a processor, an antenna, or a computer system that can analyze and process sensor data. The location of the electric component or electronic is for illustration only, and it is understood that the electrical component 514 can be disposed anywhere in the display housing 502, or external to but electrically coupled to, the display housing 502.

In one example of the present disclosure, the wearable display device 500 can include a first eye region 504a integrated into the display housing 502 and a second eye region 504b integrated into the display housing 502. The first and second eye regions 504a-b can be configured to be positioned proximal the eyes of a user. The first and second eye regions 504a-b can include transparent windows, glass, apertures, etc. The first and second eye regions 504a-b can direct the user’s eyes to a single display or multiple displays, depending on the configuration.

The display housing 502 can also include a central region 506. The central region 506 can be configured to be positioned proximal, on top of, or against the nose of a user. The central region 506 can have a different depth, height, or other configuration than the first and second eye regions 504a-b. The central region 506 can include a receptacle 510. The receptacle 510 can be configured to receive a nosepiece 520. The receptacle 510 can include a coupler 512 to removably couple the nosepiece 520. The receptable 510 and coupler 512 can include an electrical connection, such that the connection between receptable 510 and/or coupler 512 and the nosepiece 530 can facilitate an electrical connection to facilitate the exchange of data between the nosepiece 530 and the electrical component 514 via an electrical pathway 516.

The nosepiece 520 can secure the wearable display device 500 to the user by engaging with, resting on, or securing the wearable display device 500 to the nose of the user. The nosepiece 520 can assist with supporting the weight of the wearable display device 500 while permitting the user to wear the wearable display device 500 for extended periods of time. To accommodate various users, the nosepiece 520 can include struts 524a-b extending from a stem 522. The stem 522 can include an electrical connection configured to electrically mate with the receptacle 510. For example, the stem 522 can include a connector 528 to electrically, mechanically, or electrically and mechanically removably couple the nosepiece to the display housing 502 or the electrical components 514 within.

The struts 524a-b can extend from the stem 522. The struts 524a-b can include electrical channels 532a-b. The struts 224a-b can include pads 526a-b. The pads 526a-b can be positioned on the distal end of the struts 524a-b, away from the stem 522. The pads 526a-b can be configured to disperse pressure on the nose of the user, thus increasing comfort and wearability. The pads 526a-b can be removably coupled to the struts 524a-b. The pads 526a-b can be electrically coupled to the struts 524a-b via an electrical connection between the pads 526a-b and the struts 524a-b, and thus electrically coupled to the electrical component 514 within the display housing 502. In an example, the pads 526a-b can include sensors 534a-b. Though the electrical connections and the electrical channels 532a-b and 516, the sensors 534a-b can be electrically connected to the electrical component 514. Therefore, the sensors 534a-b can be communicatively coupled to the electrical component 514 to exchange data and information. The sensors 534a-b can sensors configured to measure pressure, respiration, nostril movement, septum deviation, etc.

In an example, the electrical component 514 can receive input from the sensors 534a-b and perform various actions. For example, the electrical component 514 can receive information from the sensors 534a-b indicating a pressure of the pads 526a-b on the nose of the user. Based on the pressure information, the electrical component 514 can send instructions to display recommendations for adjustments or modifications of the nosepiece 520, to reduce pressure, thereby increasing comfort and duration of wearability. In an example, the wearable display device 500 may display an image and recommend the user adjust the nosepiece 520 until the image is in a designated location or orientation with respect to the user’s eyes. In combination, the electrical component 514 can be receiving sensor information, such as pressure information, from the sensor 534a-b, and modify the instructions to optimize positioning for visual display and positioning on the nose. In an example, the electrical component 514 can continuously or periodically receive pressure information from the sensors 534a-b and compare the pressure to a threshold pressure throughout the duration of the user wearing the wearable display device 500. Accordingly, if the pressure crosses a predefined threshold, the electrical component 514 can alert the user, such as via the display 503, to readjust the wearable display device 500, the nosepiece 520, or take a timed break before continuing to use to device to limit prolonged high pressure on the nose.

The electrical component 514 can receive health monitoring information from the sensors 534a-b, such as respiration, nostril movement, septum deviation, etc. Based on the health monitoring information, the electrical component 514 can display recommendations to the user via the display 503. For example, the electrical component 514 can recommend rest times during active use of the wearable display device 500, such as when exercising or playing active video games. The electrical component 514 can recommend adjustment of the nosepiece 520 or the wearable display device 500 if breathing patterns or nostril movements indicate movement of the wearable display device 500 or nosepiece 520 has impacted breathing patterns or nostril movements.

Any of the features, components, and/or parts, of the wearable display device including the arrangements and configurations thereof shown in FIG. 5 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 5.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user’s health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user’s general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to "opt in" or "opt out" of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A wearable display device, comprising:
a display;
a display housing at least partially surrounding the display; and
a nosepiece configured to be removably coupled to the display housing, the nosepiece comprising:
a stem configured to be received by the display housing;
a first strut extending away from the stem at a first angle relative to the stem;
a first pad coupled to the first strut distal to the stem;
a second strut extending away from the stem at a second angle relative to the stem; and
a second pad coupled to the second strut distal to the stem.

2. The wearable display device of claim 1, wherein:
the display housing defines a first eye region, a second eye region, and a central region extending between the first eye region and the second eye region; and
the central region defines a receptacle configured to receive the stem.

3. The wearable display device of claim 1, wherein:
the first strut extends from the stem with a first curvature; and
the second strut extends from the stem with a second curvature.

4. The wearable display device of claim 1, wherein the first angle relative to the stem and the second angle relative to the stem are adjustable.

5. The wearable display device of claim 1, wherein the stem and the display housing are removably coupled via at least one of a magnet, a detent, or a snap lock.

6. The wearable display device of claim 1, wherein the nosepiece can be removably coupled to the display housing to define a first stem angle or a second stem angle of the stem relative to the display housing.

7. The wearable display device of claim 1, wherein the first pad is removably coupled to the first strut and the second pad is removably coupled to the second strut.

8. The wearable display device of claim 7, wherein:
the first pad is removably coupled to the first strut via at least one of a snap fit, a rail, or a magnet; and
the second pad is removably coupled to the second strut via at least one of a snap fit, a rail, or a magnet.

9. The wearable display device of claim 7, wherein:
the first pad is configured to be removably coupled to the first strut at a first distance or a second distance; and
the second pad is configured to be removably coupled to the second strut at the first distance or the second distance.

10. The wearable display device of claim 1, wherein:
the first strut is configured to telescope to modify a first length of the first strut; and
the second strut is configured to telescope to modify a second length of the second strut.

11. The wearable display device of claim 1, wherein:
the first pad comprises a first pressure sensor; and
the second pad comprises a second pressure sensor.

12. A wearable display device, comprising:
a display;
a display housing comprising a central region defining a receptacle; and
a nosepiece, comprising:
a stem configured to be received by the receptacle at a first angle relative to the housing and be removably coupled to the central region of the display housing;
a first strut extending away from the stem with a first curvature;
a first pad removably coupled to the first strut;
a second strut extending away from the stem with a second curvature; and
a second pad removably coupled to the second strut.

13. The wearable display device of claim 12, wherein a distance between the first pad and the second pad is adjustable.

14. The wearable display device of claim 12, wherein:
a first location of the first pad on the first strut is adjustable; and
a second location of the second pad on the second strut is adjustable.

15. The wearable display device of claim 12, wherein the stem comprises an electrical connection configured to electrically mate with the receptacle.

16. The wearable display device of claim 15, wherein:
the wearable display device comprises an electronic disposed within the housing;
the first pad is configured to electrically couple to the electronic via the electrical connection; and
the second pad is configured to electrically couple to the electronic via the electrical connection.

17. The wearable display device of claim 12, wherein the receptacle is configured to receive the stem at the first angle, a second angle, and a third angle relative to the display housing.

18. The wearable display device of claim 12, wherein the second curvature mirrors the first curvature.

19. A nosepiece, comprising:
a stem comprising a connector, wherein the connector is configured to be removably coupled to a wearable display device and wherein the connector is configured to electrically couple the nosepiece to the wearable display device;
a first strut extending away from the stem;
a second strut extending away from the stem;
a first pad removably coupled to the first strut, the first pad comprising a first sensor electrically couplable to the connector; and
a second pad removably coupled to the second strut, the second pad comprising a second sensor electrically couplable to the connector.

20. The nosepiece of claim 19, wherein the first sensor comprises a first pressure sensor and the second sensor comprises a second pressure sensor.
